(19) United States
(12) Patent Application Publication
(10) Pub. No.: US 2023/0282000 A1
(43) Pub. Date: Sep. 7, 2023

(54) MULTI-OBJECT TRACKING

(71) Applicant: Ford Global Technologies, LLC, Dearborn, MI (US)

(72) Inventors: Su Pang, Okemos, MI (US); Marcos Paul Gerardo Castro, San Francisco, CA (US); Jinhyoung Oh, Union City, CA (US); Clifton K. Thomas, Palo Alto, CA (US); Jinesh Jain, Pacifica, CA (US)

(73) Assignee: Ford Global Technologies, LLC, Dearborn, MI (US)

(21) Appl. No.: 17/684,509

(22) Filed: Mar. 2, 2022

(51) Int. Cl. G06V 20/56; G01S 13/86; G01S 13/72; G01S 13/931; G01S 7/41; G06V 10/80

(52) U.S. Cl. CPC G06V 20/56; G01S 13/867; G01S 13/726; G01S 13/931; G01S 7/412; G06V 10/803; B60W 60/0027

(57) ABSTRACT

At a first timestep, one or more first objects can be determined in a first fusion image based on determining one or more first radar clusters in first radar data and determining one or more first two-dimensional bounding boxes in first camera data. First detected objects and first undetected objects can be determined by inputting the first objects and the first radar clusters into a data association algorithm, which determines first probabilities and adds the first radar clusters and the first objects to one or more of first detected objects or first undetected objects by determining a cost function. The first detected objects and the first undetected objects can be input to a first Poisson multi-Bernoulli mixture (PMBM) filter to determine second detected objects, second undetected objects and second probabilities. The second detected objects and the second undetected objects can be reduced based on the second probabilities determined by the first PMBM filter and the second detected objects can be output.

### BACKGROUND

Images can be acquired by sensors and processed using a computer to determine data regarding objects in an environment around a system. Operation of a sensing system can include acquiring accurate and timely data regarding objects in the system's environment. A computer can acquire images from one or more images sensors that can be processed to determine locations of objects. Object location data extracted from images can be used by a computer to operate systems including vehicles, robots, security, and object tracking systems.

### BRIEF DESCRIPTION OF THE DRAWINGS

FIG. 1 is a block diagram of an example traffic infrastructure system.

FIG. 2 is a diagram of an example image of a traffic scene.

FIG. 3 is a diagram of radar point cloud data of a traffic scene.

FIG. 4 is a diagram of an example convolutional neural network.

FIG. 5 is a diagram of an example image with bounding boxes.

FIG. 6 is a diagram of example radar data/camera image processing system.

FIG. 7 is a diagram of example combined radar data and camera data.

FIG. 8 is a diagram of an example object tracking system.

FIG. 9 is a diagram of example object tracking.

FIG. 10 is a flowchart diagram of an example process to track objects.

FIG. 11 is a flowchart diagram of an example process to operate a vehicle based on tracked objects.

### DETAILED DESCRIPTION

A sensing system can acquire data, for example image data, regarding an environment around the system and process the data to determine types, dimensions, poses, and/or locations of objects. For example, a software program, including a deep neural network (DNN), can be trained and then used to determine objects in image data acquired by sensors in systems including vehicle guidance, robot operation, security, manufacturing, and product tracking. Vehicle guidance can include operation of vehicles in autonomous or semi-autonomous modes in environments that include a plurality of objects. Robot guidance can include guiding a robot end effector, for example a gripper, to pick up a part and orient the part for assembly in an environment that includes a plurality of parts. Security systems include features where a computer acquires video data from a camera observing a secure area to provide access to authorized users and detect unauthorized entry in an environment that includes a plurality of users. In a manufacturing system, a DNN can determine the location and orientation of one or more parts in an environment that includes a plurality of parts. In a product tracking system, a deep neural network can determine a location and orientation of one or more packages in an environment that includes a plurality of packages.

Vehicle guidance will be described herein as a non-limiting example of using a computer to determine objects, for example vehicles and pedestrians, in a traffic scene and determine a vehicle path for operating a vehicle based on the determined objects. A traffic scene is an environment around a traffic infrastructure system or a vehicle that can include a portion of a roadway and objects including vehicles and pedestrians, etc. A computing device in a vehicle or traffic infrastructure system can be programmed to acquire one or more images from one or more sensors included in the vehicle or the traffic infrastructure system, determine objects in the images and communicate labels that identify the objects along with locations of the objects.

A determined object can include an object state, i.e., a set of physical measurements describing an object at a certain time, and which can be described using a four element vector that includes an object location in x and y real world coordinates with respect to a top-down map and object velocities vₓ, v_{y} determined in real world coordinates with respect to the x and y directions. An object can be detected, where the object state is included in an output object tracks set that plots an object's location on the top-down map over a plurality of time steps. An object can also be undetected, where object can include an object state but not be included in an output object tracks set. Objects can be determined to be detected or undetected based on probabilities included in the object. Techniques discussed herein use a Poisson multi-Bernoulli mixture (PMBM) filter to determine detected and undetected objects based on the included probabilities.

The sensors can include video or still image cameras that acquire images corresponding to reflected or emitted visible or infrared wavelengths of light and radar sensors that acquire point cloud data that measures distances to objects and surfaces in the environment. The sensors can be included in the vehicle or can be stationary and can be mounted on poles, buildings, or other structures to give the sensors a view of the traffic scene including objects in the traffic scene. In some examples sensors included in a vehicle can acquire one or more images or frames of video data and one or more point clouds of radar data process the images and point cloud data to determine tracks of objects included in the images and point clouds. Tracks refer to determining a speed and direction of an object. Determining object tracks can permit a computing device in a vehicle to determine a vehicle path upon which to operate the vehicle by permitting the computing device to predict future locations for the object.

Advantageously, techniques described herein may increase the efficiency of a computing device in a vehicle to predict future locations of objects in an environment around the vehicle using a camera sensor and a radar sensor. A monocular camera includes a single lens assembly having a single optical axis that forms images on a single sensor or sensor assembly. An RGB camera is a camera that acquires color image data that includes separate red, green and blue pixels. Images acquired by a monocular RGB camera can be combined with radar point cloud data and processed using PMBM filters as described herein to determine object tracking data from monocular RGB image data and radar point cloud data. Determining object tracking data using PMBM filters to process combined camera and radar data provides more reliable object tracking data using fewer computing resources compared to systems using either monocular RGB images or radar point cloud data alone, or systems that combine monocular RGB images with radar point cloud data after processing.

Disclosed herein is a method including, at a first timestep, determining one or more first objects in a first fusion image based on determining one or more first radar clusters in first radar data and determining one or more first two-dimensional bounding boxes and first confidence values in first camera data. The first detected objects and first undetected objects can be determined by inputting the first objects and the first radar clusters into a data association algorithm, which determines first probabilities and adds the first radar clusters and the first objects to one or more of the first detected objects or the first undetected objects by determining a cost function based on the first probabilities. The first detected objects and the first undetected objects can be input to a first Poisson multi-Bernoulli mixture (PMBM) filter to determine second detected objects and second undetected objects and second probabilities. The disclosed method further includes reducing the second detected objects and the second undetected objects based on the second probabilities and the second probabilities determined by the first PMBM filter and outputting the second detected objects.

At a second timestep, one or more second objects in a second fusion image can be determined based on determining one or more second radar clusters in second radar data and determining one or more second two-dimensional bounding boxes in second camera data. The second detected objects and the second undetected objects can be input to a second PMBM filter to determine updated second detected objects and updated second undetected objects. The second objects, the second radar clusters, the updated second detected objects and the updated second undetected objects can be input into the data association algorithm, which determines third probabilities and generates one or more of third detected objects and third undetected objects by adding the second objects and the second radar clusters to one or more of the updated second detected objects and the updated second undetected objects. New third detected objects and new third undetected objects can be generated by determining the cost function based on the third probabilities. The third detected objects and the third undetected objects can be input to the first PMBM filter to determine fourth detected objects and fourth undetected objects and fourth probabilities. The fourth detected objects and the fourth undetected objects based on the fourth probabilities determined by the first PMBM filter can be reduced, and the fourth detected objects can be output.

A vehicle can be operated based determining a vehicle path based on the second detected objects. An object can be a vector that includes x and y locations and velocities in x and y measured in real world coordinates. The first radar clusters can be determined based on determining a core groups of radar data points that have a minimum number of neighboring radar data points within a user-determined maximum threshold distance and then determining the first radar clusters based on radar data points within user-determined maximum threshold distance of the core groups of radar data points. The first objects including the first two-dimensional bounding boxes and confidence values in the first camera data can be determined by inputting the first camera data to one or more of a convolutional neural network, a histograms of oriented gradients software program, a region-based fully convolutional network, a single shot detector software program and a spatial pyramid pooling software program. The first fusion image can be determined by projecting pillars determined based on centers of the radar cluster and object height and width determined by one or more of machine learning or user-determined object height and width onto the first two-dimensional bounding boxes based on a radar camera matching metric and radar pillars.

The first detected objects and the second detected objects can include x, y coordinates and velocities vₓ and v_{y} in the x and y directions, respectively, measured in real world coordinates with respect to a top-down map. The first probabilities can be based on the first confidence values and confidence between the first radar clusters and the first objects. A Poisson point process random finite set (RFS) can model the first undetected objects and the second undetected objects, a multi-Bernoulli mixture RFS can model the first detected objects and the second detected objects and the PMBM filter can combine the estimates of the first undetected objects, the second undetected objects, the first detected objects and the second detected objects. The first and second PMBM filters can include convolving the Poisson RFS with the multi-Bernoulli mixture RFS. The data association algorithm can add the first radar clusters and the first objects to the first detected objects, the second detected objects, the first undetected objects and the second undetected objects, respectively, based on a cost determined by one or more of a Hungarian algorithm and Murty's algorithm. The Murty's algorithm can minimize the cost for k objects based on a cost matrix, wherein k is a user-determined number, and the cost matrix is based on object to object measurement distances and object probabilities. Reducing can include one or more of pruning, which removes first detected tracks based on probabilities, capping, which sets a user-determined upper bound on a number of objects, gating, which limits a search distance for combining objects, recycling, which generates undetected objects from detected objects based on low object probabilities, and merging, which generates one object from two or more objects.

Further disclosed is a computer readable medium, storing program instructions for executing some or all of the above method steps. Further disclosed is a computer programmed for executing some or all of the above method steps, including a computer apparatus, programmed to, at a first timestep, determine one or more first objects in a first fusion image based on determining one or more first radar clusters in first radar data and determine one or more first two-dimensional bounding boxes and first confidence values in first camera data. First detected objects and first undetected objects can be determined by inputting the first objects and the first radar clusters into a data association algorithm, which determines first probabilities and adds the first radar clusters and the first objects to one or more of the first detected objects or the first undetected objects by determining a cost function based on the first probabilities. The first detected objects and the first undetected objects can be input to a first Poisson multi-Bernoulli mixture (PMBM) filter to determine second detected objects and second undetected objects and second probabilities. The instructions can include further instructions to reduce the second detected objects and the second undetected objects based on the second probabilities and the second probabilities determined by the first PMBM filter and outputting the second detected objects.

The instructions can include further instructions to, at a second timestep, determine one or more second objects in a second fusion image based on determining one or more second radar clusters in second radar data and determining one or more second two-dimensional bounding boxes in second camera data. The second detected objects and the second undetected objects can be input to a second PMBM filter to determine updated second detected objects and updated second undetected objects and the second objects. The second radar clusters, the updated second detected objects and the updated second undetected objects can be input into the data association algorithm, which determines third probabilities and generates one or more of third detected objects and third undetected objects by adding the second objects and the second radar clusters to one or more of the updated second detected objects and the updated second undetected objects. New third detected objects and new third undetected objects can be generated by determining the cost function based on the third probabilities. The third detected objects and the third undetected objects can be input to the first PMBM filter to determine fourth detected objects and fourth undetected objects and fourth probabilities. The fourth detected objects and the fourth undetected objects based on the fourth probabilities determined by the first PMBM filter can be reduced, and the fourth detected objects can be output.

The instructions can include further instructions to operate a vehicle based determining a vehicle path based on the second detected objects. An object can be a vector that includes x and y locations and velocities in x and y measured in real world coordinates. The first radar clusters can be determined based on determining a core groups of radar data points that have a minimum number of neighboring radar data points within a user-determined maximum threshold distance and then determining the first radar clusters based on radar data points within user-determined maximum threshold distance of the core groups of radar data points. The first objects including the first two-dimensional bounding boxes and confidence values in the first camera data can be determined by inputting the first camera data to one or more of a convolutional neural network, a histograms of oriented gradients software program, a region-based fully convolutional network, a single shot detector software program and a spatial pyramid pooling software program. The first fusion image can be determined by projecting pillars determined based on centers of the radar cluster and object height and width determined by one or more of machine learning or user-determined object height and width onto the first two-dimensional bounding boxes based on a radar camera matching metric and radar pillars.

The instructions can include further instructions to determine the first detected objects and the second detected objects including x, y real world coordinates and velocities vₓ and v_{y} in the x and y directions, respectively, measured in real world coordinates with respect to a top-down map. The first probabilities can be based on the first confidence values and confidence between the first radar clusters and the first objects. A Poisson point process random finite set (RFS) can model the first undetected objects and the second undetected objects, a multi-Bernoulli mixture RFS can model the first detected objects and the second detected objects and the PMBM filter can combine the estimates of the first undetected objects, the second undetected objects, the first detected objects and the second detected objects. The first and second PMBM filters can include convolving the Poisson RFS with the multi-Bernoulli mixture RFS. The data association algorithm can add the first radar clusters and the first objects to the first detected objects, the second detected objects, the first undetected objects and the second undetected objects, respectively, based on a cost determined by one or more of a Hungarian algorithm and Murty's algorithm. The Murty's algorithm can minimize the cost for k objects based on a cost matrix, wherein k is a user-determined number, and the cost matrix is based on object to object measurement distances and object probabilities. Reducing can include one or more of pruning, which removes first detected tracks based on probabilities, capping, which sets a user-determined upper bound on a number of objects, gating, which limits a search distance for combining objects, recycling, which generates undetected objects from detected objects based on low object probabilities, and merging, which generates one object from two or more objects.

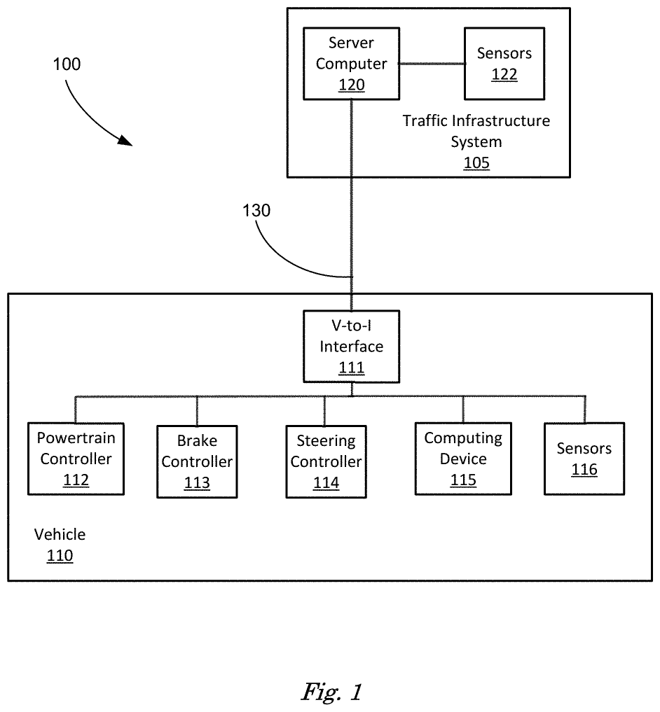

FIG. 1 is a diagram of a sensing system 100 that can include a traffic infrastructure system 105 that includes a server computer 120 and stationary sensors 122. Sensing system 100 includes a vehicle 110, operable in autonomous (“autonomous” by itself in this disclosure means “fully autonomous”), semi-autonomous, and occupant piloted (also referred to as non-autonomous) mode. One or more vehicle 110 computing devices 115 can receive data regarding the operation of the vehicle 110 from sensors 116. The computing device 115 may operate the vehicle 110 in an autonomous mode, a semi-autonomous mode, or a non-autonomous mode.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (e.g., control of acceleration in the vehicle 110 by controlling one or more of an internal combustion engine, electric motor, hybrid engine, etc.), steering, climate control, interior and/or exterior lights, etc., as well as to determine whether and when the computing device 115, as opposed to a human operator, is to control such operations.

The computing device 115 may include or be communicatively coupled to, e.g., via a vehicle communications bus as described further below, more than one computing devices, e.g., controllers or the like included in the vehicle 110 for monitoring and/or controlling various vehicle components, e.g., a powertrain controller 112, a brake controller 113, a steering controller 114, etc. The computing device 115 is generally arranged for communications on a vehicle communication network, e.g., including a bus in the vehicle 110 such as a controller area network (CAN) or the like; the vehicle 110 network can additionally or alternatively include wired or wireless communication mechanisms such as are known, e.g., Ethernet or other communication protocols.

Via the vehicle network, the computing device 115 may transmit messages to various devices in the vehicle and/or receive messages from the various devices, e.g., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V-to-I) interface 111 with a remote server computer 120, e.g., a cloud server, via a network 130, which, as described below, includes hardware, firmware, and software that permits computing device 115 to communicate with a remote server computer 120 via a network 130 such as wireless Internet (WI-FI®) or cellular networks. V-to-I interface 111 may accordingly include processors, memory, transceivers, etc., configured to utilize various wired and/or wireless networking technologies, e.g., cellular, BLUETOOTH® and wired and/or wireless packet networks. Computing device 115 may be configured for communicating with other vehicles 110 through V-to-I interface 111 using vehicle-to-vehicle (V-to-V) networks, e.g., according to Dedicated Short Range Communications (DSRC) and/or the like, e.g., formed on an ad hoc basis among nearby vehicles 110 or formed through infrastructure-based networks. The computing device 115 also includes nonvolatile memory such as is known. Computing device 115 can log data by storing the data in nonvolatile memory for later retrieval and transmittal via the vehicle communication network and a vehicle to infrastructure (V-to-I) interface 111 to a server computer 120 or user mobile device 160.

As already mentioned, generally included in instructions stored in the memory and executable by the processor of the computing device 115 is programming for operating one or more vehicle 110 components, e.g., braking, steering, propulsion, etc., without intervention of a human operator. Using data received in the computing device 115, e.g., the sensor data from the sensors 116, the server computer 120, etc., the computing device 115 may make various determinations and/or control various vehicle 110 components and/or operations without a driver to operate the vehicle 110. For example, the computing device 115 may include programming to regulate vehicle 110 operational behaviors (i.e., physical manifestations of vehicle 110 operation) such as speed, acceleration, deceleration, steering, etc., as well as tactical behaviors (i.e., control of operational behaviors typically in a manner intended to achieve efficient traversal of a route) such as a distance between vehicles and/or amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to monitor and/or control a specific vehicle subsystem. Examples include a powertrain controller 112, a brake controller 113, and a steering controller 114. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110 may include known electronic control units (ECUs) or the like including, as non-limiting examples, one or more powertrain controllers 112, one or more brake controllers 113, and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computing device 115 and control actuators based on the instructions.

Sensors 116 may include a variety of devices known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and/or other sensors 116 and/or the geographical coordinates provided by the GPS sensor may be used by the computing device 115 to operate the vehicle 110 autonomously or semi-autonomously, for example.

The vehicle 110 is generally a land-based vehicle 110 capable of autonomous and/or semi-autonomous operation and having three or more wheels, e.g., a passenger car, light truck, etc. The vehicle 110 includes one or more sensors 116, the V-to-I interface 111, the computing device 115 and one or more controllers 112, 113, 114. The sensors 116 may collect data related to the vehicle 110 and the environment in which the vehicle 110 is operating. By way of example, and not limitation, sensors 116 may include, e.g., altimeters, cameras, LIDAR, radar, ultrasonic sensors, infrared sensors, pressure sensors, accelerometers, gyroscopes, temperature sensors, pressure sensors, hall sensors, optical sensors, voltage sensors, current sensors, mechanical sensors such as switches, etc. The sensors 116 may be used to sense the environment in which the vehicle 110 is operating, e.g., sensors 116 can detect phenomena such as weather conditions (precipitation, external ambient temperature, etc.), the grade of a road, the location of a road (e.g., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to controllers 112, 113, 114 in the vehicle 110, connectivity between components, and accurate and timely performance of components of the vehicle 110.

Vehicles can be equipped to operate in both autonomous and occupant piloted mode. By a semi- or fully-autonomous mode, we mean a mode of operation wherein a vehicle can be piloted partly or entirely by a computing device as part of a system having sensors and controllers. The vehicle can be occupied or unoccupied, but in either case the vehicle can be partly or completely piloted without assistance of an occupant. For purposes of this disclosure, an autonomous mode is defined as one in which each of vehicle propulsion (e.g., via a powertrain including an internal combustion engine and/or electric motor), braking, and steering are controlled by one or more vehicle computers; in a semi-autonomous mode the vehicle computer(s) control(s) one or more of vehicle propulsion, braking, and steering. In a non-autonomous mode, none of these are controlled by a computer.

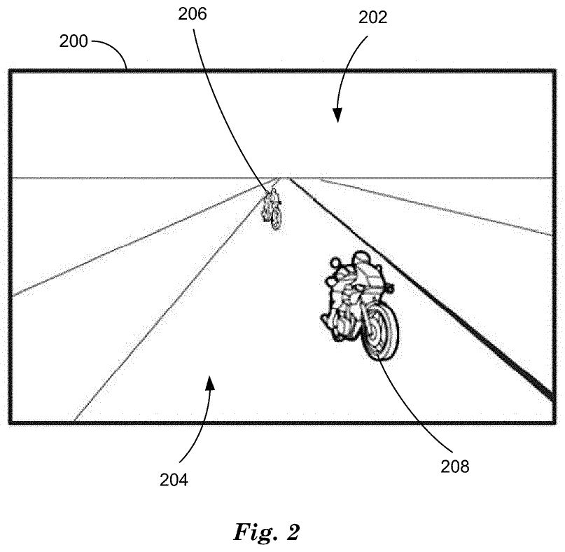

FIG. 2 is a diagram of an image 200 of a traffic scene 202. Traffic scene 202 includes a roadway 204, and vehicles 206, 208, in this example motorcycles. Vehicles 206, 208 can be moving with respect to the traffic scene 202. Image 200 can be acquired by a camera, which can be a color or red, green, blue (RGB) video camera included in a vehicle 110 The image 200 of traffic scene 202 can be acquired by a sensor 116, which can be a monocular red, green, blue (RGB) video camera included in a vehicle 110. The monocular RGB video camera can acquire a plurality of images 200 as frames of RGB image data at frame rates of up to 60 frames per second, for example. The image 200 can also be acquired by a monochrome or infrared camera at frame rates that can vary from fewer than one frame per second up to more than 60 frames per second. The image 200 can also be acquired by a stationary sensor 122 included in a traffic infrastructure system 105. The stationary sensor 122 can be mounted on a camera mount, which can include traffic signal poles, light poles, purpose-built poles or mounts, buildings, or existing structures such as bridges, overpasses, or sign poles. The image 200 acquired by a stationary sensor 122 can be communicated to a computing device 115 in a vehicle 110 by a server computer 120 included in a traffic infrastructure system 105, for example. Image 200 includes high-resolution images of vehicles 206, 208 and can be processed to determine vehicle 206, 208 labels. i.e., in this example, motorcycles, and high-resolution data regarding the x, y locations of the vehicles 206, 208 with respect to the image 200 data array.

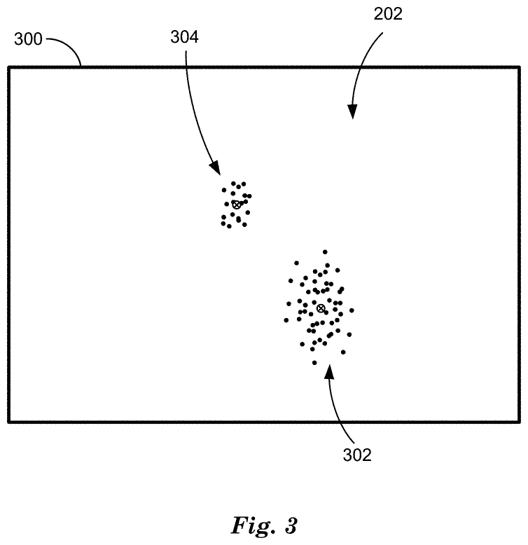

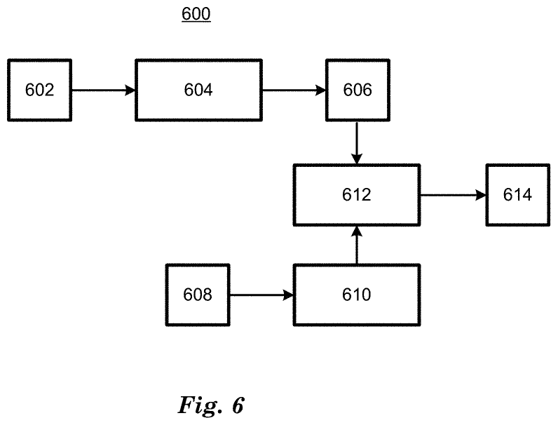

FIG. 3 is a diagram of a radar point cloud image 300 of traffic scene 202 acquired by a radar sensor included in vehicle 110 at substantially the same time as image 200 was acquired by a video camera. The radar point cloud image 300 includes radar point cloud clusters 302, 304, formed by grouping received radar data points reflected from vehicles 206, 208 in traffic scene 202 into clusters. Grouping radar data points into radar point cloud clusters is discussed in relation to FIG. 6, below. Radar point cloud clusters 302, 304 include values that indicate the distance or range from the radar sensor to the radar data points included in the radar point cloud clusters 302, 304, however, the low spatial resolution available in the radar point cloud clusters 302, 304 makes it difficult to identify the radar point cloud clusters 302, 304 as vehicles, much less what type of vehicles. Low spatial resolution also makes it difficult to determine accurate the x, y locations of the radar point clouds 302, 304 in the radar point cloud image 300 data array.

Tracking objects in an environment around a vehicle 110 can provide data that permits a computing device 115 in a vehicle 110 to determine a vehicle path upon which to operate. A vehicle path can be a polynomial function in a two-dimensional plane, for example a roadway surface, upon which a computing device 115 can operate a vehicle 110 by transmitting commands to vehicle controllers 112, 113, 114 to control one or more of vehicle powertrain, vehicle steering, and vehicle brakes. The polynomial function can be determined to direct the vehicle 110 from one position on a roadway to a second position on the roadway while maintaining upper and lower limits on vehicle lateral and longitudinal accelerations. Predicting locations of moving objects in the environment around a vehicle can permit a computing device 115 to determine a vehicle path that permits the vehicle 110 to travel efficiently to reach a determined location in the environment.

Tracking multiple objects in an environment based on vehicle sensor data includes challenges. The first challenge is that determining the correct number and location of objects in sensor data includes inherent uncertainties. Rapidly changing data, complex traffic scenes, limited time and limited computing resources means that some level uncertainty will be included in object tracking data. Secondly, the complex three-dimensional nature of traffic scenes means that tracked objects can appear and disappear from view as objects are occluded by other objects such as other vehicles or portions of the scene such a foliage, for example. Thirdly, a tracked object can disappear as is moves out of the field of view of the sensor. Fourthly, tracked objects can change state, for example changing speed, direction, or stopping. In addition to these challenges, the acquired object data is subject to variations due to weather and lighting conditions. Radar point cloud data can be too sparse to support object detection and camera data does not provide range or distance data. An object tracking technique as discussed herein can overcome these challenges by combining radar and camera data as a random finite set (RFS) and inputting the RFS to a multi-object tracking (MOT) system based on PMBM filters to increase efficiency of tracking multiple objects in real time using limited computing resources. An object tracking technique based on radar and image data using PMBM filters as discussed herein can track multiple objects in real time using computing resources available in a typical computing device 115 included in a vehicle 110.

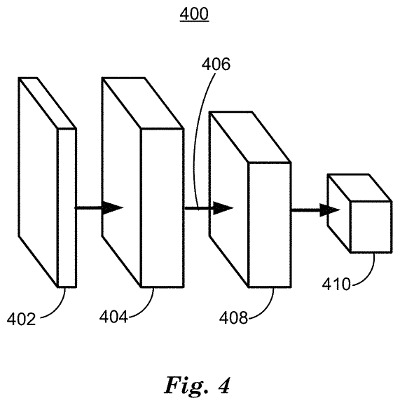

FIG. 4 is a diagram of a convolutional neural network (CNN) 400. A CNN 400 inputs an image 402 to convolutional layers 404 which convolve the input image 402 with a plurality of convolutional kernels that encode objects included in the input image 402 as latent variables 406. The latent variables 406 are processed by fully connected layers 408 which calculate linear and non-linear functions on the latent variables 406 to determine output predictions 410. Output predictions 410 can include labels and locations of objects included in the input images 402, for example. CNNs 400 can be trained to output predictions by compiling a training dataset of images including ground truth regarding labels and locations of objects in the images included in the training dataset. Ground truth regarding the labels and location of objects can be determined by acquiring both lidar data and images of a traffic scene and combining locations determined based on the lidar data with labels determined by inspecting the images, for example.

The training dataset can include thousands of images with ground truth data regarding objects included in the images. At training, each image can be processed by the CNN to provide an output prediction which is compared to the ground truth data by a loss function which measures how closely the output prediction compares to the ground truth. The loss function is provided to the convolutional layers 404 and fully connected layers 408 to select weights which program the convolutional kernels and linear and non-linear functions. Weights can be selected that over a plurality of trials provide output predictions that approximate the ground truth to train the CNN 400. Using a training dataset with ground truth data, a CNN 400 can be trained to output bounding boxes and a confidence value for objects included in the input images. A bounding box is the smallest enclosing rectangle that surrounds an object. A confidence value is a probability that the CNN 400 has correctly labeled and determined a bounding box for an object.

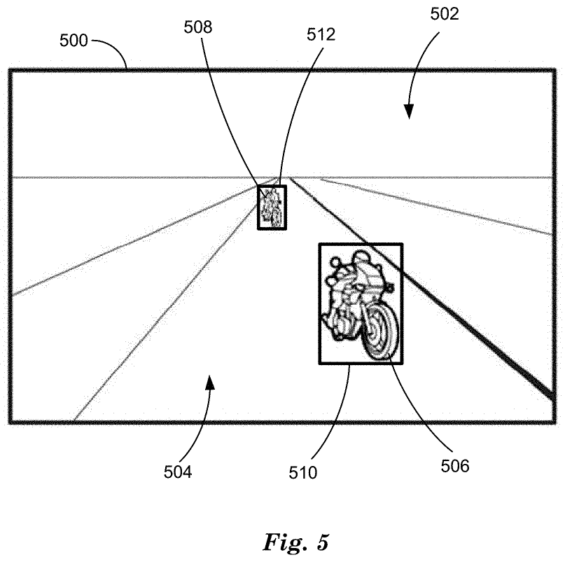

FIG. 5 is a diagram of an image 500 of a traffic scene 502 including a roadway 504 and two objects 506, 508. Image 500 can be input to a trained CNN 400 to determine label and location objects 506, 508. A computing device 115 can use the label and location data output from CNN 400 to determine bounding boxes 510, 512 for objects 506, 508, respectively. Bounding boxes 510, 512 label the objects 506, 508 as “motorcycles” and locate them within the image 500 data array. Techniques discussed herein combine labels and locations of objects 506, 508 with radar point cloud data acquired at substantially the same time as the image 500 was acquired by an RGB video camera.

FIG. 6 is a diagram of a data fusion system 600. Data fusion system 600 inputs a radar detections 602 into a radar preprocessor 604. Radar preprocessor 604 identifies radar point cloud clusters in a radar detections 602 based on cluster analysis. Cluster analysis identifies one or more radar point cloud clusters as objects by using a density-based cluster analysis, for example. Density-based cluster analysis forms radar point cloud clusters by grouping radar image data points together based on determining a core groups of radar data points that have a minimum number of neighboring radar data points within a user-determined maximum threshold distance and then determining the first radar clusters based on radar data points within user-determined maximum threshold distance of the core groups of radar data points. Radar point cloud clusters can be determined to be radar objects based on the number of radar data points included in the radar point cloud cluster and the area and average density of the radar point cloud cluster exceeding user-selected minimums. Radar objects are identified by the x, y location of the center of radar point cloud cluster and include the average distance of the radar point cloud cluster from the radar sensor.

Radar objects based on radar point cloud clusters 606 are output to radar/camera projection 612 for combining with objects determined in a camera image 608. A camera image 608 acquired at substantially the same time as the radar image detections 602 is input to camera image processing 610. Camera image processing 610 can include a CNN 400 as described above in relation to FIG. 4. Other image processing software that can process camera images to determine objects and generate bounding boxes includes (1) Histogram of Oriented Gradients (HOG) discussed in Dalal, Navneet, and Bill Triggs. “Histograms of oriented gradients for human detection.” 2005 IEEE computer society conference on computer vision and pattern recognition (CVPR'05) 2005, (2) Region-based Fully Convolutional Network (R-FCN) discussed in Dai, Jifeng, et al. “R-fcn: Object detection via region-based fully convolutional networks.” Advances in neural information processing systems 29 (2016), Single Shot Detector (SSD) discussed in Liu, W., Anguelov, D., Erhan, D., Szegedy, C., Reed, S., Fu, C. Y., & Berg, A. C. (2016, October), (3) Ssd: Single shot multibox detector, discussed in European conference on computer vision (pp. 21-37), Springer, and (4) Spatial Pyramid Pooling (SPP-net) discussed in He, K., Zhang, X., Ren, S., & Sun, J. (2015). Spatial pyramid pooling in deep convolutional networks for visual recognition. IEEE transactions on pattern analysis and machine intelligence, 37(9), 1904-1916.

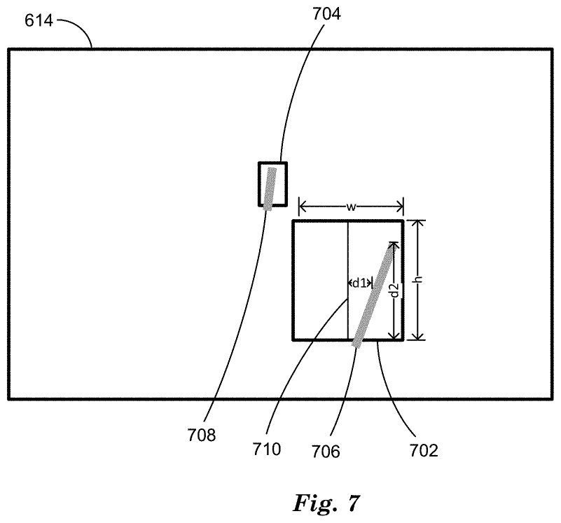

Image processing software can apply bounding boxes 510, 512 and a confidence value for each bounding box 510, 512 to the camera image 608 and pass the results to radar/camera projection 612. At camera/radar projection 612, a previously determined radar camera matching metric that defines a relationship between locations in camera images and distances and locations of radar point cloud clusters 606 are used to combine bounding boxes 510, 512 and radar pillars determined based on radar objects. Relationships between locations in camera images and distances and locations of radar point cloud clusters can be determined bases on calibration data determined at the time the cameras and radar sensor are installed in the vehicle 110. Radar pillars will be discussed in relation to FIG. 7, below. The relationship between bounding boxes 510, 512 and distances and locations of radar objects can be determined based on the location and orientation of the fields of view of the camera and the field of view of the radar sensor with respect to the vehicle 110. The relationship between bounding boxes 510, 512 and distances and locations of radar objects can also be based on the location of a ground plane assumed to be coincident with the roadway upon which the vehicle is operating. Combined camera/radar objects based one or more bounding boxes 510, 512 and one or more combined radar/camera objects 614 are output to object tracking system 800. Combined camera/radar objects include a confidence value output by CNN 400.

FIG. 7 is diagram of a combined camera/radar objects 614 from FIG. 6. Combined camera/radar image 700 is determined by camera/radar projection 612. Combined camera/radar objects 614 include bounding boxes 702, 704 that can be based on objects detected in an input camera image 608 by camera image processing 610 discussed in relation to FIG. 6, above. Combined camera/radar objects 614 can also include radar pillars 706, 708. Radar pillars are generated based on radar objects output from radar data preprocessor 604. Because automotive radar sensors typically do not directly measure the height and width of objects, the height and width of objects determined based on radar objects are estimated based on the location and orientation of the radar sensor with respect to a ground plane and extrinsic parameters of the radar sensor, including field of view and magnification. To overcome the lack of height data, the radar objects are expanded into variable height radar pillars 706, 708 based on the center of the radar point cloud clusters. Given a distance from the radar sensor as indicated in the radar object, a location in the radar image can be determined based on the intersection of the radar object with an assumed ground plane. The height of the radar pillar can be determined based on a determined height and width of the radar object and the distance of the point cloud cluster from the sensor. The height and width of the radar object can be determined based on processing the radar data with a machine learning program. The machine learning program can be trained based on user determined ground truth. In some examples the height and width of the radar object can determined based on user input. A radar pillar 706, 708 can be drawn on the combined camera/radar objects 614 from the ground plane intersection point to a height based on the distance of the radar object from the sensor. The closer the radar pillar 706, 708 is to the sensor, the greater the height and width of the radar pillar 706, 708 in the combined camera/radar objects 614. The tilt of the radar pillar 706, 708 is based on the relationship between the fields of view of the video camera and the radar sensor. For example, a wide-angle lens on the video camera will cause the radar pillar 706, 708 to slant away from vertical to mimic the distortion caused by the wide-angle lens.

Combined camera/radar object can be determined by projecting radar pillars 706, 708 determined based on a radar image detections 602 onto bounding boxes 702, 704 from a camera image 608. Combining radar pillars 706, 708 are acquired at substantially the same time as the camera image 608 can reduce the number of false positive radar objects. Camera/radar projection 612 can reject as a false positive any radar pillars 706, 708 that do not occur in combined with a camera image 608 bounding box 702, 704. The combination between a bounding box 702 and a radar pillar 706 can be quantified by the equation:

(w−d1)*d2/(w*h)>threshold (1)

Where w and h are the width and height of the bounding box 702, d1 is the distance between a centerline 710 of the bounding box 702 and the radar pillar 706, d2 is the overlapped height of the bounding box 702 and the radar pillar 706 and threshold is a user determined value. When the quantity (w−d1)*d2/(w*h) exceeds the threshold the radar pillar 706, 708 is determined to be a true positive, i.e., the radar pillar 706, 708 is confirmed to be a combined image/radar object based on the bounding box 702. When the quantity (w−d1)*d2/(w*h) does not exceed the threshold, the radar pillar 706, 708 can be determined to be a false positive and deleted. Confirming radar pillars 706, 708 in this fashion reduces the occurrence of false positive returns, increases the reliability of object tracking and reduces the amount of computing resources devoted to calculating false object tracks. Combined image/radar objects include the x, y center of the bounding box 702, 704, the distance of the radar object from the radar sensor and a confidence value output by CNN 400.

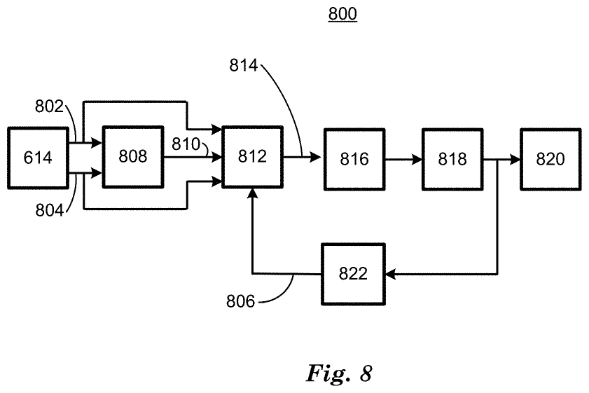

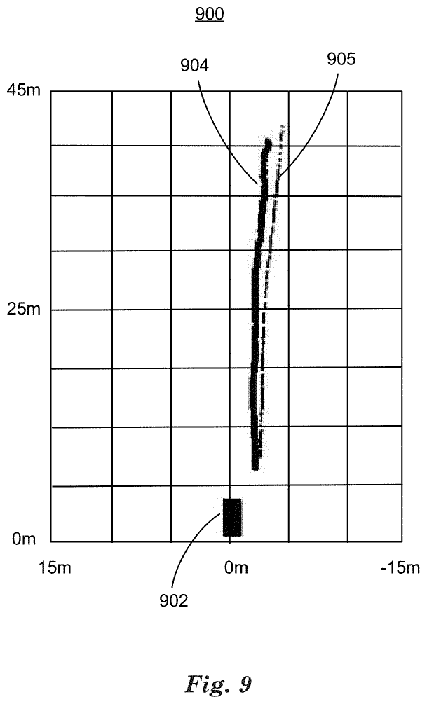

FIG. 8 is a diagram of an object tracking system 800 that inputs bounding boxes 802 and projected radar pillars 804, combined camera/radar objects 614 output from data fusion system 600 and outputs object tracks set 820. The output object tracks set 820 is a connected series of object locations included in a top-down map. The output object tracks set 820 is illustrated in a top-down map 900 in FIG. 9. Object tracking system 800 is an iterative process, inputting a plurality of radar clusters 606 and combined camera/radar objects 614 at successive time steps and outputting one or more object tracks set 820. At each time step object tracking system 800 can update object tracks set 820 based on newly acquired radar point cloud clusters 606 and combined camera/radar objects 614. Object tracking system 800 includes both detected objects and undetected objects. A detected object is a radar object or combined camera/radar object 614 that has been determined by object tracking system 800 to have a high probability of being included in the output object tracks set 820 and includes an object state vector=[x, y, vₓ, v_{y}]. Object state vector includes an x, y location and velocities vₓ, v_{y} in the x and y direction measured in real world coordinates with respect to a ground plane viewed from a top-down perspective. The ground plane is assumed to be parallel to a roadway surface that supports the vehicle 110 that acquired the radar and camera data. The ground plane can be illustrated as a top-down map, which is a map of an environment around a vehicle as viewed from directly above. Undetected objects are radar point cloud clusters 606 or combined camera/radar objects 614 that include an object state vector but have not been included in the output tracks set 820 by object tracking system 800.

A detected object can remain detected even though it can become temporarily obscured. For example, an object such as a vehicle being tracked by object tracking system 800 can pass behind another vehicle or be temporarily block from visibility by foliage or a building. Rather than deleting the object, the tracking system 800 retains the object as a detected object, with the probability of existence in Bernoulli distribution reduced for that timestep. If the probability of existence is still larger than a threshold, the object will be included in the output tracks set. When the object comes back into the view of camera or radar sensors, object tracking system 800 can set the probability of existence in Bernoulli distribution back to 1.0 for that timestep and keep tracking the object.

At top-down data association 808, locations of radar point cloud clusters 606 and combined camera/radar objects 614 are projected onto a top-down map of the environment to form object data points 810. Locations of object data points 810 in the top-down map are relative to the location of the vehicle 110. Distances and directions from the vehicle 110 to the radar point cloud clusters 606 and combined camera/radar objects 614 can determined based on the distance data values included in the radar point cloud clusters 606 and combined camera/radar objects 614. The distance and direction to the radar point cloud clusters 606 and combined camera/radar objects 614 can determine the location of object data point 810 in the top-down map.

Object data points 810 in the top-down map include weights or probabilities of existence. A weight is a probability that there is a real physical object at the real world location indicated by the object data point in the top-down map. Radar pillars 706, 708 that are included in a bounding box 702, 704 according to equation (1) have a high weight or high probability of indicating real world objects at the indicated real world location. Radar point clouds 302, 304 that are not included in a bounding box 702, 702 are assigned low weights or low probability of indicating real world objects at the indicated real world location. A probability or weight is a number from 0.0 to 1.0, where low probabilities are typically between 0.0 and 0.2 and high probabilities can be between 0.8 and 1.0, for example.

Object data points 810 are output from top-down data association 808 to data association 812 along bounding boxes 802 and projected radar pillars 804 where the object data points 810 are combined with updated detected objects and undetected objects 806 from a previous iteration. Object tracking system 800 is an iterative process, and except for the first iteration, updated detected objects and undetected objects 806 from the previous iteration are available at data association 808. Data association 808 can associate object data points 810 with previously detected objects to determine newly detected objects. A detected object track is a group of one or more detected objects from two or more iterations that have been shown to include a constant velocity relationship by PMBM filter update 816. Undetected tracks can include a single undetected object or a plurality of undetected objects but does not assume a constant velocity relationship between the object data points 810. Both detected object track and undetected object track are modelled using constant velocity model. The difference between detected object tracks and undetected object tracks is that detected object tracks are included in the final output tracks set, while undetected object tracks are not. Undetected tracks are tracked in the “background”, meaning that they are tracked but not output, because the object tracking system 800 does have enough evidence to validate their existence, while we are certain about the existence of detected object tracks. An object track is validated when the probability of its existence is determined be 1.0 by PMBM filter update 816. A constant velocity relationship is where x, y locations of an object data point 810 at successive time steps can be determined because of the object moving at constant velocities vₓ, v_{y} in the x and y directions, respectively.

Data association 808 can generate a detected object based on an object data point 810 when the object data point 810 has a high weight, i.e., when both radar data and image data confirm the existence of the object data point 810. Data association 808 can also generate a detected object when the cost of associating the new object data point 810 with a previously detected object is lower than a user determined threshold. When the object data point has low weight, i.e., when one of radar data and image data but not both confirm the existence of the object data point, 810, data association 808 can generate a new undetected object. An undetected object is an object data point 810 that is not associated with a detected object. Data association compares the new object data points 810 to previously determined detected objects 806 from a previous iteration to determine whether to associate a new object data point 810 with a previously detected object.

Data association 812 determines detected objects and undetected objects from object data points 810 by performing cost analysis on the tracks and objects. A cost value is associated with each object data point 810 based on the distance of the new object data point 810 from a previous detected object and modified by the track weight and detected/undetected status. Cost is proportional to distance, i.e., a small distance between an object data point and a track has a small cost and a large distance between an object data point and a track has a high cost. The relationship between cost and distance can be empirically determined by inspecting a plurality of tracks and object locations. A high track weight or high probability reduces the cost of associating an object data point 810 with a detected object. Likewise, detected status reduces the cost of associating an object with a track, while undetected status increases the cost. When the cost of generating a new track is lower than combining the new object data point with an existing track, a new track is generated. The cost function can be evaluated using a Hungarian algorithm or Murty's algorithm, which ranks all the potential assignments of object data points 810 to exiting objects according to cost and makes the assignments in increasing order of cost. A Murty algorithm minimizes a cost for k object assignments based on a cost matrix, where k is a user-determined number, and the cost matrix is based on object to object measurement distances and object probabilities. The new detected objects and undetected objects can be re-weighted based on the object data points 810 included in the new detected objects and undetected objects. An object updated by including an object data point 810 confirmed in both radar and image data according to equation (1) is increased in probability. A track updated by including a track updated with an object data point 810 confirmed in radar data only is unchanged in weight. A track updated with an object data point 810 confirmed in image data only has the weight increased slightly in proportion to a confidence value output by the CNN 400 when the object is detected. A track that is not updated with any object data point 810 has the weight decreased because no object data point 810 detects the track. Object data points 810 having very low probability and high costs relative to detected objects is likely a false positive and can be discarded.

Detected objects and undetected objects 814 output to PMBM filter update 816 to determine object states for the detected and undetected objects based on object states from previous iterations. Object state prediction is a Bayesian process, where probabilities associated with a previous step are used to update probabilities at a current step. The prediction step can be written as:

PMBM_{t+1|t}(Xₜ₊₁)=∫p(Xₜ₊₁|Xₜ)PMBM_{t|t}(Xₜ)δXₜ (2)

Where X is the random finite set (RFS) of object states x₁, . . . xₙ, PMBM_{t+1|t} are the object states Xₜ₊₁ the at time t+1 conditioned on the object states at time t, p(Xₜ₊₁|Xₜ) are the probabilities associated with the object states at time t+1 determined based on the previous probabilities associated with object states at time t, and PMBM_{t|t} is the previous object state probability distribution. The PMBM filter update 816 is a convolution of a Poisson RFS probability distribution for undetected objects and a multi-Bernoulli mixture RFS probability density for detected objects:

PMBMₜ(X)=Σ_{X}_{^{u}}_{∪X}_{^{d}}_{=X}Pₜ(X^{u})MBMₜ(X^{d}) (3)

Where X is all objects, X^{u} is the undetected objects and X^{d} is the detected objects.

Undetected objects are modeled using a Poisson point process (PPP) random finite set (RFS). A Poisson point process describes statistics where a single event, such as an object location, is taken from a very large universe of potential events, such as all possible object locations. A Poisson point process can also be described as a probability associated with a time of an event occurring. A Poisson process P(k) is described by the equation:

$$P ( k ) = \frac{λ {e}^{- λ}}{k !} \qquad ( 4 )$$

Where k is the number of events and λ is the average rate of events occurring. In a Poisson point process, the variance of the Poisson distribution is equal to the square root of the mean. Object states for new undetected objects are determined based on probabilities associated with previous undetected object states assuming a Poisson distribution using Bayesian inference.

Detected objects are modeled using a multi-Bernoulli mixture (MBM) RFS distribution. A Bernoulli distribution is a statistical test that has a binary result, for example “1” or “0”, and no other possible answer. For example, repeated coin tosses will result in a Bernoulli distribution. An MBM distribution includes a plurality of separate events each of which has a binary outcome. The probability distribution function of a Bernoulli distribution B(k) is described by the equations:

$$B ( k ) = \{ \begin{matrix}p & for k = 1 \\ 1 - p & for k = 0\end{matrix} \} \qquad ( 5 )$$

The MBM filter determines object states to be assigned to a multiple detected objects based on multiple previous object states using Bayesian inference. Where the probability is low that a new detected object is associated with a previously detected object, the MBM distribution returns a value of 0 for the object state. This can occur when a detected object is obscured from view of vehicle sensors, for example when an object such as a vehicle passes behind another vehicle. Setting the object state to zero does not delete the detected object, so when the object returns to view, for example coming out from behind an obscuring vehicle or foliage, the MBM filter can assign a value based on a linear velocity model to the detected object. Following estimating undetected object with a PPP and estimating detected objects with a MBM, the estimated undetected objects and detected objects are combined with a PMBP filter to update the estimated undetected objects and detected objects as discussed above.

Following PMBM filter update 816, the detected and undetected objects are input to reduction 818. Reduction 818 reduces the number of detected and undetected objects by one or more of pruning, capping, gating, recycling, and merging. Pruning removes detected objects from detected tracks based on low object probabilities. Capping removes objects by setting a user-determined upper bound on the total number of objects permitted. Gating limits a search distance for data association. In this example Mahalanobis distance is used instead of Euclidean distance to measure distances between objects based on their probabilities. Recycling generates undetected objects from detected objects based on low object probability of existence. Merging generates one global hypothesis of object existence from two or more identical global hypotheses of object existence.

Following reduction 818, detected objects are combined into object tracks set 820 and output to computing device 115 where they can be used to operate a vehicle 110. The output object tracks set 820 is a connected set of object states. Object states are assigned to the output object tracks set 820 based on being identified by the PMBM filter as being the same detected object. Computing device can determine a vehicle path for vehicle 110 based on object tracks and predicted future locations of objects based on the detected object's x and y velocities. Detected objects and undetected objects are also output to prediction PMBM filter 822 which can predict the probabilities associated with the detected and undetected objects according to equation (2), above. The predicted objects 806 can be output to data association 812 where newly acquired object data points 810 can be combined with the predicted objects 806 at the next iteration.

FIG. 9 is a diagram of a top-down map 900. X and Y axes on the top-down map 900 indicate distances in meters. Top-down map 900 includes a vehicle icon 902 that indicates the location of a vehicle 110. Included in top-down map 900 is a detected track 904 from object tracks set 820 output from object tracking system 800. Also included in top-down map 900 is ground truth data 905 for a tracked object included as detected track 904. Ground truth data 905 can be acquired by a lidar sensor included in vehicle 110, for example, and can be used to train CNN 400 as discussed in relation to FIG. 4, above.

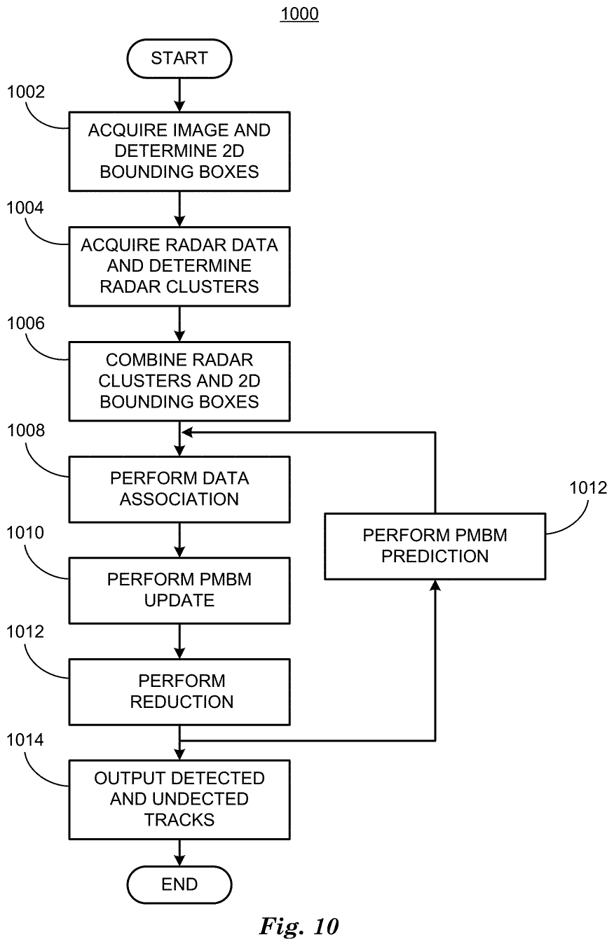

FIG. 10 is a flowchart, described in relation to FIGS. 1-9, of a process 1000 for tracking objects in radar data and images acquired by sensors 116 included in a vehicle 110. Process 1000 can be implemented by a processor of a computing device 115, taking as input image data from sensors 116, executing commands, and outputting object tracks set 820 to a computing device 115. Process 1000 includes multiple blocks that can be executed in the illustrated order. Process 1000 could alternatively or additionally include fewer blocks or can include the blocks executed in different orders.

Process 1000 begins at block 1002, where a computing device 115 inputs an image 402 of a traffic scene to a CNN 400. The image 402 can be acquired by an RGB video camera included in a vehicle 110. The CNN 400 can output object labels that identify objects and locations of objects in pixel coordinates with respect to the image array. The CNN 400 can also output confidence values that are probabilities that the object labels and locations have been correctly determined by the CNN 400 as discussed above in relation to FIGS. 2 and 4. Computing device 115 can determine bounding boxes 510, 512 at the object locations determined by CNN 400.

At block 1004 a computing device 115 acquires radar data from a radar sensor included in a vehicle 110. The computing device 115 can perform cluster analysis on the radar data to determine radar point cloud clusters 302, 304 that indicate objects in the radar data as discussed in relation to FIG. 3, above.

At block 1006 computing device 115 combines the radar point cloud clusters 302, 304 and image bounding boxes 510, 512 as discussed above in relation to FIGS. 6 and 7.

At block 1008 an object tracking system 800 as discussed in relation to FIG. 8, above, included in computing device 115 inputs radar point cloud clusters 606 and combined camera/radar objects 614. Object tracking system 800 includes top-down data association 808 that generates object data points 810 from radar point cloud clusters 606 and objects included in combined camera/radar objects 614 and determines the locations of object data points 810 on a top-down map 900. The object data points 810 are input to data association 812 where newly determined object data points 810 are combined with predicted detected objects 806 from a previous iteration of the object tracking system 800 by determining a cost function. The combined detected objects and undetected objects 814 are input to a PMBM filter to update probabilities or track weights for the detected and undetected objects.

At block 1010 the detected objects and undetected objects 814 are input to reduction 818 to reduce the number of tracks.

At block 1012 the reduced detected and undetected objects are passed to prediction PMBM filter 822 to predict the detected objects and undetected objects 814 based on the time step before being returned to as predicted detected objects and undetected objects 806 to data association 812.

At block 1014 the reduced detected and undetected tracks are output to computing device 115 to be used to operate vehicle 110. Following block 1014 process 1000 ends.

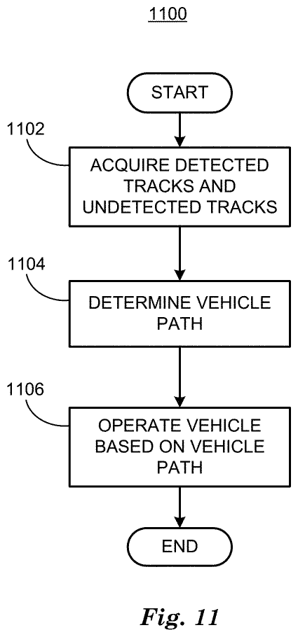

FIG. 11 is a diagram of a flowchart, described in relation to FIGS. 1-10, of a process for operating a vehicle 110 based on detected objects and undetected objects 814 determined by object tracking system 800 described in process 1000 in FIG. 10, above. Process 1100 can be implemented by a processor of a computing device 115, taking as input data from sensors 116, and executing commands, and operating vehicle 110. Process 1100 includes multiple blocks that can be executed in the illustrated order. Process 1100 could alternatively or additionally include fewer blocks or can include the blocks executed in different orders.

Process 1100 begins at block 1102, where a computing device 115 in a vehicle 110 receives detected objects and undetected objects 814 based on image 200 data and radar point cloud image 300 data from an object tracking system 800 as described in relation to FIGS. 2-10.

At block 1104 computing device 115 determines a vehicle path based on the locations of object data points 810 included in detected objects and undetected objects 814. A vehicle path is a polynomial function that includes maximum and minimum lateral and longitudinal accelerations to be applied to vehicle motion as it travels along the vehicle path. Object data points 810 included in detected tracks include x and y velocities with respect to a top-down map 900 which permits computing device 115 to predict future locations for the object data points 810.

At block 1106 computing device 115 outputs commands to controllers 112, 113, 114 to control vehicle powertrain, vehicle steering, and vehicle brakes to control vehicle motion to operate vehicle 110 along the vehicle path determined at block 1104. Following block 1106 process 1100 ends.

Computing devices such as those discussed herein generally each includes commands executable by one or more computing devices such as those identified above, and for carrying out blocks or steps of processes described above. For example, process blocks discussed above may be embodied as computer-executable commands.

Computer-executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (e.g., a microprocessor) receives commands, e.g., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, e.g., a reference to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same reference numbers indicate the same elements. Further, some or all of these elements could be changed. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A computer, comprising:
a processor; and
a memory, the memory including instructions executable by the processor to:
at a first timestep, determine one or more first objects in a first fusion image based on determining one or more first radar clusters in first radar data and determining one or more first two-dimensional bounding boxes and first confidence values in first camera data;
determine first detected objects and first undetected objects by inputting the first objects and the first radar clusters into a data association algorithm, which determines first probabilities and adds the first radar clusters and the first objects to one or more of the first detected objects or the first undetected objects by determining a cost function based on the first probabilities;
input the first detected objects and the first undetected objects to a first Poisson multi-Bernoulli mixture (PMBM) filter to determine second detected objects and second undetected objects and second probabilities;
reduce the second detected objects and the second undetected objects based on the second probabilities determined by the first PMBM filter; and
output the second detected objects.

2. The computer of claim 1, the instructions including further instructions to:
at a second timestep, determine one or more second objects in a second fusion image based on determining one or more second radar clusters in second radar data and determining one or more second two-dimensional bounding boxes in second camera data;
input the second detected objects and the second undetected objects to a second PMBM filter to determine updated second detected objects and updated second undetected objects and third probabilities;
input the second objects, the second radar clusters, the updated second detected objects and the updated second undetected objects into the data association algorithm, which generates one or more third detected objects and third undetected objects by adding the second objects and the second radar clusters to one or more of the updated second detected objects and the updated second undetected objects or generating new third detected objects and new third undetected objects by determining the cost function based on the third probabilities;
input the third detected objects and the third undetected objects to the first PMBM filter to determine fourth detected objects and fourth undetected objects and fourth probabilities;
reduce the fourth detected objects based on the fourth probabilities determined by the first PMBM filter; and
output the fourth detected objects.

3. The computer of claim 1, the instructions including further instructions to operate a vehicle based determining a vehicle path based on the second detected objects.

4. The computer of claim 1, wherein an object is a vector that includes x and y locations and velocities in x and y measured in real world coordinates.

5. The computer of claim 1, the instructions including further instructions to determine the first radar clusters based on determining a core groups of radar data points that have a minimum number of neighboring radar data points within a user-determined maximum threshold distance and then determining the first radar clusters based on radar data points within user-determined maximum threshold distance of the core groups of radar data points.

6. The computer of claim 5, the instructions including further instructions to determine the first objects including the first two-dimensional bounding boxes and confidence values in the first camera data by inputting the first camera data to one or more of a convolutional neural network, a histograms of oriented gradients software program, a region-based fully convolutional network, a single shot detector software program and a spatial pyramid pooling software program.

7. The computer of claim 1, the instructions including further instructions to determine the first fusion image by projecting pillars determined based on centers of the radar cluster and object height and width determined by one or more of machine learning or user-determined object height and width onto the first two-dimensional bounding boxes based on a radar camera matching metric and radar pillars.

8. The computer of claim 1, wherein the first detected objects and the second detected objects include x, y coordinates and velocities vₓ and v_{y} in the x and y directions, respectively, measured in real world coordinates with respect to a top-down map.

9. The computer of claim 1, wherein the first probabilities are based on the first confidence values and confidence between the first radar clusters and the first objects.

10. The computer of claim 1, wherein a Poisson point process random finite set (RFS) models the first undetected objects and the second undetected objects, a multi-Bernoulli mixture RFS models the first detected objects and the second detected objects and the PMBM filter combines estimates of the first undetected objects, the second undetected objects, the first detected objects and the second detected objects.

11. The computer of claim 10, wherein the first and second PMBM filters include convolving the Poisson point process RFS with the multi-Bernoulli mixture RFS.

12. The computer of claim 1, wherein the data association algorithm adds the first radar clusters and the first objects to the first detected objects, the second detected objects, the first undetected objects and the second undetected objects, respectively, based on a cost determined by one or more of a Hungarian algorithm and Murty's algorithm.

13. The computer of claim 12, wherein the Murty's algorithm minimizes the cost for k objects based on a cost matrix, wherein k is a user-determined number, and the cost matrix is based on object to object measurement distances and object probabilities.

14. The computer of claim 1, wherein reducing includes one or more of pruning, which removes first detected tracks based on probabilities, capping, which sets a user-determined upper bound on a number of objects, gating, which limits a search distance for combining objects, recycling, which generates undetected objects from detected objects based on low object probabilities, and merging, which generates one object from two or more objects.

15. A method, comprising:
at a first timestep, determining one or more first objects in a first fusion image based on determining one or more first radar clusters in first radar data and determining one or more first two-dimensional bounding boxes and first confidence values in first camera data;
determining first detected objects and first undetected objects by inputting the first objects and the first radar clusters into a data association algorithm, which determines first probabilities and adds the first radar clusters and the first objects to one or more of the first detected objects or the first undetected objects by determining a cost function based on the first probabilities;
inputting the first detected objects and the first undetected objects to a first Poisson multi-Bernoulli mixture (PMBM) filter to determine second detected objects and second undetected objects and second probabilities;
reducing the second detected objects and the second undetected objects based on the second probabilities and the second probabilities determined by the first PMBM filter; and
outputting the second detected objects.

16. The method of claim 15, further comprising:
at a second timestep, determining one or more second objects in a second fusion image based on determining one or more second radar clusters in second radar data and determining one or more second two-dimensional bounding boxes in second camera data;
inputting the second detected objects and the second undetected objects to a second PMBM filter to determine updated second detected objects and updated second undetected objects;
inputting the second objects, the second radar clusters, the updated second detected objects and the updated second undetected objects into the data association algorithm, which determines third probabilities and generates one or more of third detected objects and third undetected objects by adding the second objects and the second radar clusters to one or more of the updated second detected objects and the updated second undetected objects or generating new third detected objects and new third undetected objects by determining the cost function based on the third probabilities;
inputting the third detected objects and the third undetected objects to the first PMBM filter to determine fourth detected objects and fourth undetected objects and fourth probabilities;
reduce the fourth detected objects and the fourth undetected objects based on the fourth probabilities determined by the first PMBM filter; and
output the fourth detected objects.

17. The method of claim 15, further comprising operating a vehicle based determining a vehicle path based on the second detected objects.

18. The method of claim 15, wherein an object is a vector that includes x and y locations and velocities in x and y measured in real world coordinates.

19. The method of claim 15, further comprising determining the first radar clusters based on determining a core groups of radar data points that have a minimum number of neighboring radar data points within a user-determined maximum threshold distance and then determining the first radar clusters based on radar data points within user-determined maximum threshold distance of the core groups of radar data points.

20. The method of claim 19, further comprising determining the first objects including the first two-dimensional bounding boxes and confidence values in the first camera data by inputting the first camera data to one or more of a convolutional neural network, a histograms of oriented gradients software program, a region-based fully convolutional network, a single shot detector software program and a spatial pyramid pooling software program.
